(19) United States
(12) Patent Application Publication
(10) Pub. No.: US 2010/0180205 A1
(43) Pub. Date: Jul. 15, 2010

(54) METHOD AND APPARATUS TO PROVIDE USER INTERFACE AS A SERVICE

(75) Inventors: Kalyani A. Deshpande, Pune (IN); Anshu N. Jain, Bangalore (IN); Senthil Kk Mani, Gurgaon (IN); Thejaswini Ramachandra, Yorktown Heights, NY (US); Vibha S. Sinha, New Delhi (IN); Piyawadee Sukaviriya, Armonk, NY (US)

Correspondence Address: Ryan, Mason & Lewis, LLP, Suite 205, 1300 Post Road, Fairfield, CT, 06824, US

(73) Assignee: International Business Machines Corporation, Armonk, NY (US)

(21) Appl. No.: 12/353,349

(22) Filed: Jan. 14, 2009

(51) Int. Cl. G06F 3/00

(52) U.S. Cl. 715/744

(57) ABSTRACT

A user interface service composer determines, based on a user interface request from a user interface consumer, one of a plurality of user interface service providers to be invoked; and consults a particular entry (corresponding to the service provider to be invoked) in a user interface data catalog having a plurality of entries for the plurality of user interface service providers. A request message, for rendering a user interface requested in the user interface request received from the user interface consumer, is routed from the user interface service composer to the given one of the plurality of user interface service providers that is to be invoked. The request message includes configuration parameters and interaction-related data, and is formatted in accordance with the particular entry in the user interface data catalog. The user interface service composer receives, from the given one of the plurality of user interface service providers that is to be invoked, the user interface requested in the user interface request received from the user interface consumer; and forwards, to the user interface consumer, the user interface requested in the user interface request received from the user interface consumer.

### FIELD OF THE INVENTION

The present invention relates to the electrical, electronic and computer arts, and, more particularly, to user interfaces and the like.

### BACKGROUND OF THE INVENTION

User interfaces (UIs) address presentation of content, and interaction with respect to such content, for the user consuming the UI. Initially, UIs were tightly coupled, allowing minimum reuse of either content or presentation. However, the “model view controller” (MVC) architecture has allowed decoupling of presentation from the actual content, with the model being the interface between the two. At run-time, content can be obtained from various sources, and then embedded in the presentation or layout, to render it via the model. Even though it brings some loose coupling, the MVC pattern needs to be encoded in a single program, and the presentation, content and interactions are part of the same application.

### SUMMARY OF THE INVENTION

Principles of the invention provide techniques for providing a user interface as a service. In one aspect, an exemplary method (which can be computer-implemented) includes the steps of determining, with a user interface service composer, based on a user interface request from a user interface consumer, one of a plurality of user interface service providers to be invoked; and consulting, by the user interface service composer, a particular entry in a user interface data catalog having a plurality of entries for the plurality of user interface service providers. The particular entry corresponds to that given one of the plurality of user interface service providers that is to be invoked. An additional step includes routing, from the user interface service composer to the given one of the plurality of user interface service providers that is to be invoked, a request message for rendering a user interface requested in the user interface request received from the user interface consumer. The request message includes configuration parameters and interaction-related data, and is formatted in accordance with the particular entry in the user interface data catalog. Further steps include receiving, by the user interface service composer from the given one of the plurality of user interface service providers that is to be invoked, the user interface requested in the user interface request received from the user interface consumer; and forwarding, by the user interface service composer to the user interface consumer, the user interface requested in the user interface request received from the user interface consumer.

One or more embodiments of the invention or elements thereof can be implemented in the form of a computer product including a tangible computer usable storage medium with computer usable program code for performing the method steps indicated. Furthermore, one or more embodiments of the invention or elements thereof can be implemented in the form of an apparatus including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s), or (ii) a combination of hardware and software modules; any of (i)-(iii) implement the specific algorithms set forth herein.

One or more embodiments of the invention may offer one or more of the following technical benefits: loose coupling of user interface and content, the same content and interaction can be rendered using different UI Service Providers, and the service providers can be dynamically chosen based on context (such as end-clients with difference in display and with different style requirements).

These and other features, aspects and advantages of the present invention will become apparent from the following detailed description of illustrative embodiments thereof, which is to be read in connection with the accompanying drawings.

### BRIEF DESCRIPTION OF THE DRAWINGS

FIG. 1 shows user interface rendering in a client-server architecture, in accordance with the prior art;

FIGS. 2-4 show, respectively, an exemplary request received from a client, exemplary interaction on a UI received from the client, and exemplary registering of UI services and their identification, in a UI as a service architecture, according to an aspect of the invention;

FIG. 5 shows a UI being rendered by collaboration of presentation tier services, according to another aspect of the invention;

FIG. 6 shows a sample request message to a login page service provider, according to yet another aspect of the invention;

FIG. 7 shows a sample login page, responsive to FIG. 6, according to still another aspect of the invention;

FIG. 8 shows a sample request message to a home page service provider, according to a further aspect of the invention;

FIG. 9 shows a sample home page, responsive to FIG. 8, according to a still further aspect of the invention;

FIGS. 10 and 11 depict exemplary dynamic source discovery, according to yet a further aspect of the invention;

FIG. 12 depicts exemplary composition of a single page with widgets from multiple UI providers, according to an additional aspect of the invention;

FIG. 13 presents a flow chart of exemplary method steps, according to yet another additional aspect of the invention; and

FIG. 14 depicts a computer system that may be useful in implementing one or more aspects and/or elements of the invention.

### DETAILED DESCRIPTION OF PREFERRED EMBODIMENTS

As noted, even though it brings some loose coupling, the MVC pattern needs to be encoded in a single program, and the presentation, content and interactions are part of the same application. In one or more embodiments of the invention, there is support to dynamically choose or change the presentation based on factors such as availability of a better UI rendering available somewhere, user preferences, device type, UI technology type, and so on. The loose coupling of the prior art was in effect addressing only the techniques by which the data was obtained, while the logic of the presentation was still not configurable, or was pre-designed and implemented, and not determined at runtime. In contrast, one or more instances of the invention may provide the presentation user interface as a service, which can be invoked by any other application to render and interact with such other application's content. The service exposes an interface, via which the consumer can provide details on the content and expected interaction, alongside some configuration parameters, which allow for limited change to the actual presentation style.

Aspects of the invention provide a method and apparatus to expose and use a UI as a configurable and re-usable service, and permit visualizing the presentation tier as a configurable third party service, which, when invoked with the right semantics (content, configuration and interaction) displays the data, and allows interaction with it, in the predefined format. In some instances, a UI Service Composer invokes content services to get content to be displayed on the interface and to post back user entered data to corresponding services to save.

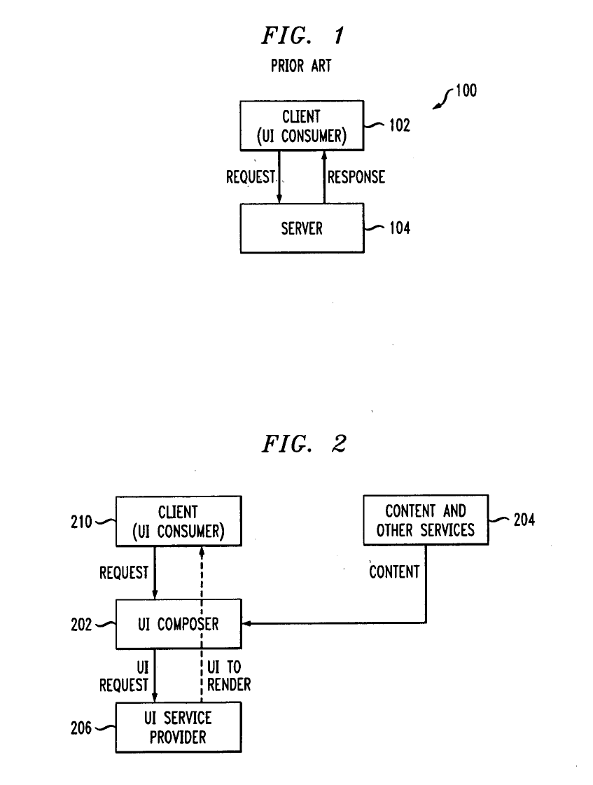

FIG. 1 shows a traditional client-server UI rendering model 100, wherein client 102 is a UI consumer, and sends a request to server 104, which responds with a response.

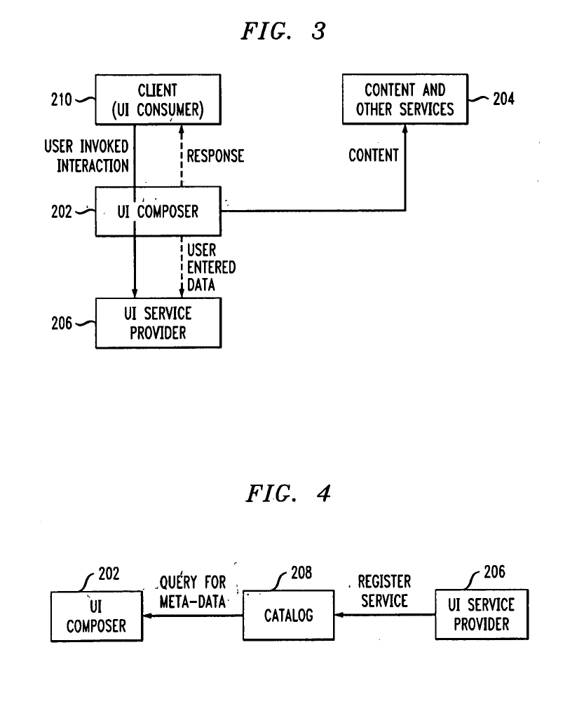

With reference now to FIGS. 2-4, in one or more embodiments of the invention, the Presentation tier is viewed now as a collection of interacting services, namely, UI Service Composer 202, Content Service 204, and UI Service Provider 206. The UI Service Catalog 208 lists UI Service Providers 206, along with their meta-information, allowing the UI Service Composer 202 to choose the appropriate UI Service provider 206 to render the User Interface for the client (UI consumer) 210.

UI Service Composer 202 handles all communication with the end-user 210 who is consuming the user interface. In one or more embodiments, composer 202 handles requests through all possible channels and then appropriately renders the user interface, coordinating with Content Services 204 and UI Service Providers 206.

With regard to UI Service Providers, block 206 can include a list of UI Rendering services which render a User Interface, given some content and control parameters. UI Service Providers 206 can vary, for example:
based on the Layout type they provide
based on the technology in which they render the UI
based on the types of UI elements they support
based on the extent of control parameters they support for configuration of the UI at runtime.

Each UI Service Provider 206 has a way of mapping the content to the User layout they provide, and prescribes semantics by which the content needs to be annotated when sent to them, which will enable them to pick up the right UI Elements and UI Layout to render the same. Each UI Service Provider, in addition to rendering the User Interface, will also be able to extract information from a UI it rendered, in terms of user entered data, input mappings to a particular interaction point on the user interface, and the like.

The Catalog 208 helps with regard to detail capturing of the meta-information associated with each UI Service Provider 206. The catalog is populated with a list of UI service Providers and their Meta-information, listed, in accordance with one or more embodiments of the invention, as UI Service Description Language (USDL). The USDL will list one or more of the following:
Input/Output messages (how content needs to be annotated in UI Service Provider semantics)
Service operations (such as createUserInterface(Content, Interaction, Configuration), extractUserEnteredData(UI Page))
Screen shot of User Interface being rendered by it
Control Parameters through which it can be configured
Set of possible interaction points supported in its layout.
Output data mapping for interaction points

This approach helps in “plug and play” of any UI Service Provider, such that same can be available in this framework for rendering the User Interface.

Aspects of the invention assist in listing UI Service Providers (by way of example and not limitation, Google Maps, http://maps.google.com/) in a Catalog, adding more annotation or meta-information about the services. The UI Service Composer then can lookup the details of the Service Provider and invoke the service provider with appropriate content fetched from content services (by way of example and not limitation, content services include Google and Amazon (http://www.amazon.com/gp/browse.html?node=3435361)).

Furthermore, aspects of the invention adhere to the MVC pattern, but further provide run time dynamism between the Mode—View and Controller, by allowing plug and play of various Content and UI Service Providers. In addition, embodiments of the invention address services oriented architecture (SOA) principles in exposing each UI Rendering component as a UI Service Provider; such providers making themselves discoverable by cataloging their information. The UI Service Composer, at run time, chooses a particular UI Service Provider, passing the content to be displayed as a request message in the semantics understood by the UI Service provider. Aspects of the invention can be applied to any presentation layer of any application, and are not restricted to any specific pattern or type of User Interface.

One or more embodiments of the invention provide a system and method for providing UIs as an external, consumable service. The architecture includes a UI composer which takes the place of the server in the traditional model, a catalog where UI services can be registered and queried for, and a service provider which provides the UI service. In at least some instances, the data to be rendered (that is, content) on the UI is provided as part of the request message to the service, and/or input from the user on the user interface is sent back to the service composer, which can then do the necessary steps of persisting and/or modifying it.

Furthermore, one or more embodiments of the invention provide a system which allows limited re-configuration of a rendered UI at runtime, based on certain request parameters, and/or a system and method where the expected interaction with the UI is mapped to an interaction point on screen (for example, a button click) as provided by the UI service in the request message. Yet further, at least some instances of the invention provide a system and method where the UI service sends back data and control to the service consumer in response to user action based on interaction logic specified in the request; a system and method where the UI service is registered in a catalog with its expected request and response format as well as meta-data which includes a screenshot of what the generated UI looks like; and/or a system and method where the traditional application providers act as UI service composers and invoke the correct UI service providers to get the presentation and route to the end consumer (in at least some instances, they also get back the data from the end consumer and route it back to the service provider).

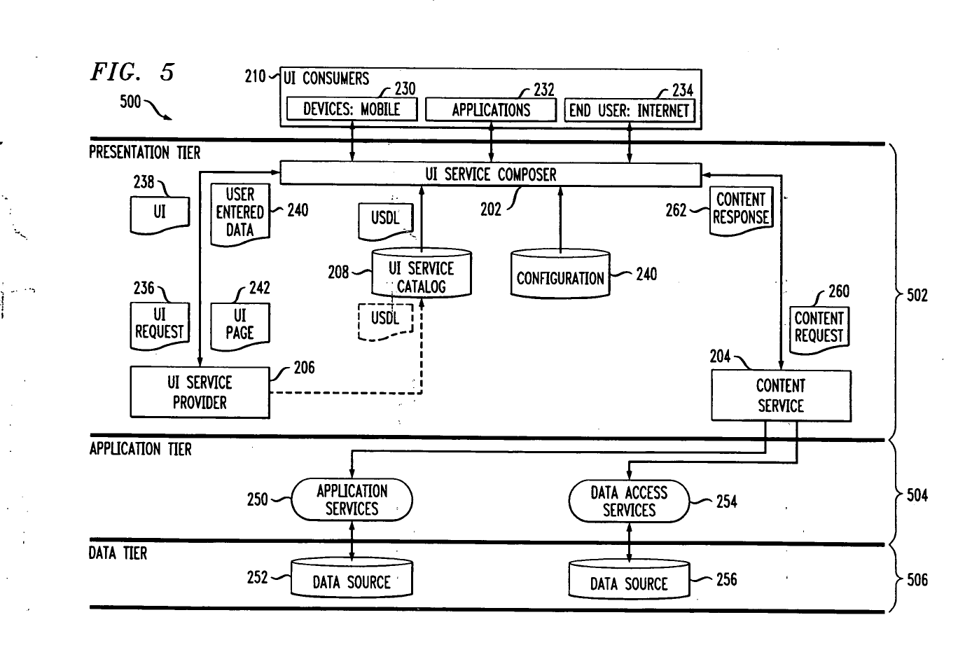

Attention should now be had to FIG. 5, for a non-limiting example of workings of an exemplary system and method, according to an aspect of the invention. Steps will be described in one logical order; however, this is purely for exemplary purposes, and in other embodiments, one or more steps may be omitted, steps may be performed in a different order, in parallel, and so on. In a first step, UI Service Composer 202, upon receiving a request from the UI Consumer 210 (for example, a mobile device 230, an application 232, and/or an Internet end user 234), will be able to determine one or more, and preferably both, of the following:
The Content Service(s) 204 that need(s) to be invoked
The UI Service Provider(s) 206 that need(s) to be invoked

This request can be the same as what is sent to the server 104 in a traditional client server application. Depending on the request, the service composer 202 identifies whether the UI, or parts of it, need to be rendered via a UI service provider 206. If so, composer 202 composes the appropriate message 236 and routes it to the service provider 206 (in one or more embodiments, the second step identified below is carried out prior to this routing, so that the message 236 has the proper semantics). The request message may include one or more, and preferably all, of the following:
The content that needs to be rendered—this can be available internally with the service composer, or it might need to invoke another set of services (called content services) to get the data
Configuration parameters to customize the UI as supported by the service provider
Interaction related data—this includes what data the composer expects back from the client when a specific interaction point on the UI is exercised.

In a second step, the Composer 202 queries the UI Service Catalog 208, to obtain the details of the UI Service Provider 206 in terms of the input message and output message format, the possible configuration parameters it can set, and the like. It then converts the content that it has to the semantics of the UI Service Provider 206, and invokes the UI Service Provider 206 with the converted content 236.

In a third step, UI Service Provider 206, upon receiving the request 236, queries its internal configuration repository on information such as, UI elements to Content Type bindings, UI Layouts and input/output mappings to interaction points on the User Interface. Using this information, it then renders the final User Interface 238 appropriately back to the UI Service Composer 202.

In a fourth step, the UI Service composer 202 then forwards the final User Interface to the end user 210 through the appropriate channel. In a fifth step, the user 210 invokes an interaction point on the UI (such as filling something in on the UI, and clicks the appropriate button). The response is routed back to the provider 206 via the service composer 202 (which acts as a router), as indicated at 242. The UI Page is sent to the provider, who extracts the user entered data and sends it back to the UI Service provider.

In a sixth step, the service provider 206 decomposes the data received from the client 210 and forwards the appropriate fields 240 (user entered data) back to the service composer 202. Exactly what provider 206 forwards back is dependant on the interaction-related data specified in the original request 236. In a seventh step, the service composer 202 gets back (i) data on what interaction point has been invoked and (ii) other appropriate data. Composer 202 can then appropriately process the data and forward the client 210 to a new target (i.e. UI).

Note that interaction between elements 202, 206, 208 can make use of the aforesaid USDL.

It will be appreciated that FIG. 5 is also representative of an exemplary (and non-limiting) architecture 500. A non-limiting exemplary rendering of a User Interface will be described as an illustrative use case. As shown in FIG. 5, a User Interface can be rendered by a collaboration of Presentation Tier Services in presentation tier 502. By way of example, to load a Login Page, the end user 210 types in a URL (on his or her browser) which points to the Login Page. The UI Service Composer 202, upon receiving the request, performs the following steps. In a first step performed by composer 202, based on the implementation logic (or configuration), composer 202 understands that it needs to render the Login Page. Composer 202 also determines whether there is any content that needs to be shown on this Login Page, and appropriately gets the Content Service Details. For illustrative purposes only, assume there is no content shown on the Login Page, and such page only has user inputs for user name and password. There is, in this non-limiting example, no content service to invoke. The implementation logic of the Service Composer 202 will have to cater to the following information (which can be, for example, ingrained or referred from a configuration store 240):
Logical User Interface to Content Service Mapping
Logical User Interface Navigation Flow
Input/Output messages of Content Services
Logical User Interface to User Service Provider mappings

From the above information, Service Composer 202 will be able to know what UI Service Provider 206 to contact, in order to get the Login Page rendered.

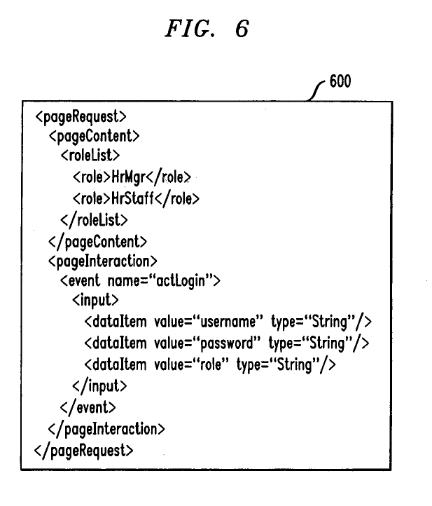

In a second step performed by composer 202, the composer 202 then queries the UI Service Catalog 208 and uses the information to appropriately transform the content and send it as a request to the UI Service Provider 206, as at 236. FIG. 6 is a sample request message 600 to a Login Page Service Provider. In a third step performed by composer 202, UI Service Provider 206 then renders the user interface with the content back to the UI Service Composer 202, as at 238. The implementation logic of the Service Provider 206 preferably has the following information to render the UI:
UI elements to Content Type mappings
Layout Elements to UI elements mapping
Interaction Points to Content Mappings
Input Control parameters to Layout and Style Mappings

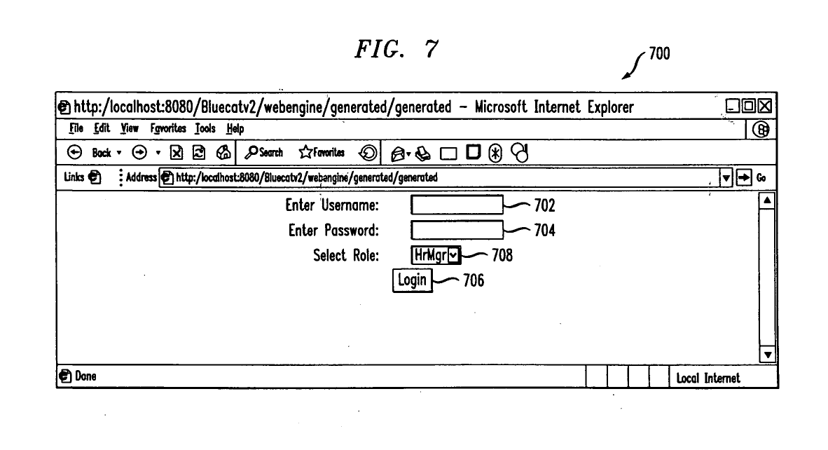

The User Interface rendered will have layout of a Login page with UI elements “username” and “password,” and the login button ( interaction point) associated with the content mapping (username and password as inputs). In a fourth step performed by composer 202, upon receiving the User Interface from the UI Service Provider 206, the composer 202 then forwards this User Interface to the appropriate end consumer 210. FIG. 7 shows an exemplary user interface 700 with aforementioned UI elements “username” 702, “password” 704, and the login button (interaction point) 706. A role selection input 708 could also be provided, for example, human resources manager or human resources staff.

A non-limiting exemplary loading of a home page will be described as another illustrative use case. End user 210 has entered the user name and password information and has pressed the “login” button (interaction point) as per FIG. 7. The request for the home page then comes to the UI Service Composer 202. In a first step of this example, the UI composer understands that it is a subsequent request (sent because of an interaction point being invoked on the UI) and composer 202 contacts the UI Service Provider 206 which rendered this User Interface to extract the User Entered Data. In a second step of this example, UI Service Provider 206 has the mapping between the interaction point and UI element input to it. Using this, provider 206 extracts the user entered data and sends it back to the UI Service Composer 202.

In a third step of this example, the composer 202 then invokes the appropriate content service 204 associated with the interaction point, to validate the Login. Upon successful login, the Service Composer 202 understands that it needs to render the Home Page associated with this login (for example, by implementation logic or referred from configuration). Composer 202 also determines the content services that will render the content for the Home Page and the associated content service(s) 204 on this Home Page that is/are required for posting the data. Composer 202 then invokes the Content services 204 to fetch the content (see content request 260 and response 262). As seen in FIG. 5, examples of content services accessed by block 204 include application services 250 in application tier 504 accessing data source(s) 252 in data tier 506, as well as data access services 254 in application tier 504 accessing data source(s) 256 in data tier 506.

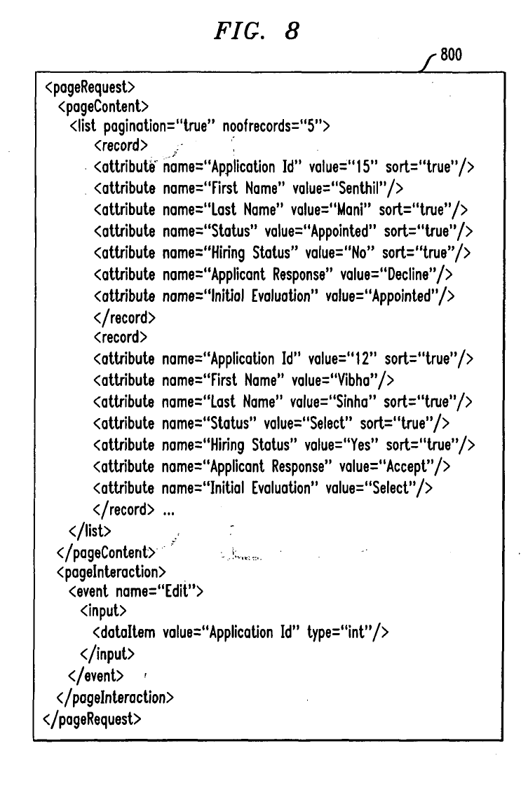

In a fourth step of this example, UI Composer 202 then queries the UI Service Catalog 208 and gets the details of the particular UI Service Provider 206 that needs to be invoked to render the User Interface for the Home Page. Composer 202 then appropriately transforms the content fetched from the content service 204 to the semantics understood by the UI Service Provider, and sends same to the UI Service Provider 206, as at 236. FIG. 8 shows a sample request message 800 to a Home Page Service Provider.

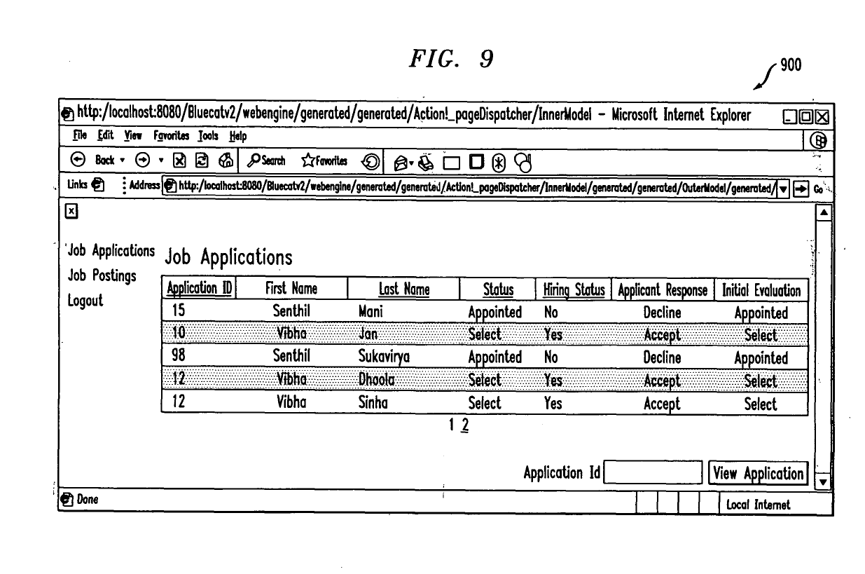

In a fifth step of this example, the UI Service Provider 206, using its meta-information, renders the User Interface, with content, back to the UI Service Composer, as at 238. In a sixth step of this example, upon receiving the User Interface from the UI Service Provider 206, the composer 202 then forwards this User Interface to the appropriate end consumer 210. FIG. 9 shows a sample home page 900 that could be rendered through the process just described.

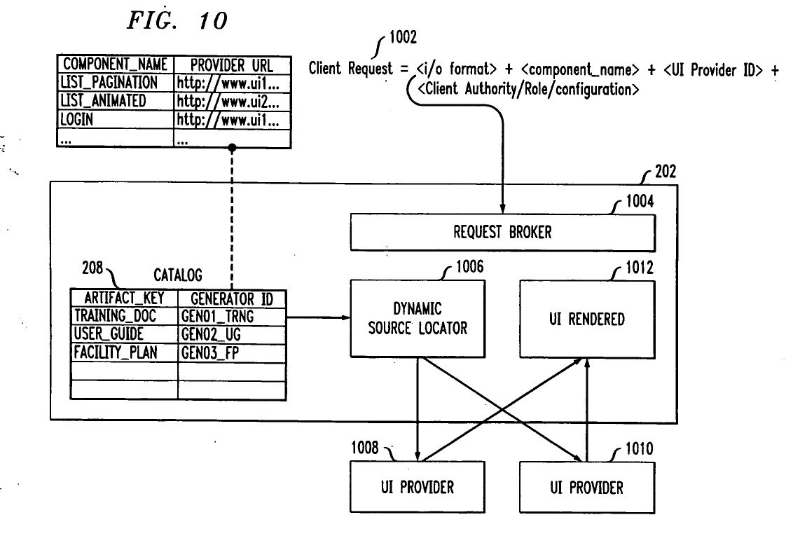

In another aspect, with reference to FIG. 10, in some instances, dynamic source discovery could be carried out based, for example, on a certain configuration. The catalog 208 might return more than one available end point for a particular UI component, and the dynamic discovery could be used to pick one of them. As seen in FIG. 10, client request 1002 is received by composer 202 which includes request broker 1004. Dynamic source locator 1006 of composer 202 determines which source 1008, 1010 is preferred for rendering the UI, as per block 1012. As best seen in FIG. 11, first provider 1008 may be a free provider, suitable for a “bare bones” UI; while second provider 1010 may be a paid service, suitable where a rich UI experience is desired. Note that the catalog data referred to with respect to FIG. 10 could be included as part of catalog 208 or separately. Note that elements 1008 and 1010 represent the UI Service Providers that have been marked as 206 in the other figures; i.e., elements 1008 and 1010 are instances of UI Service Providers 206.

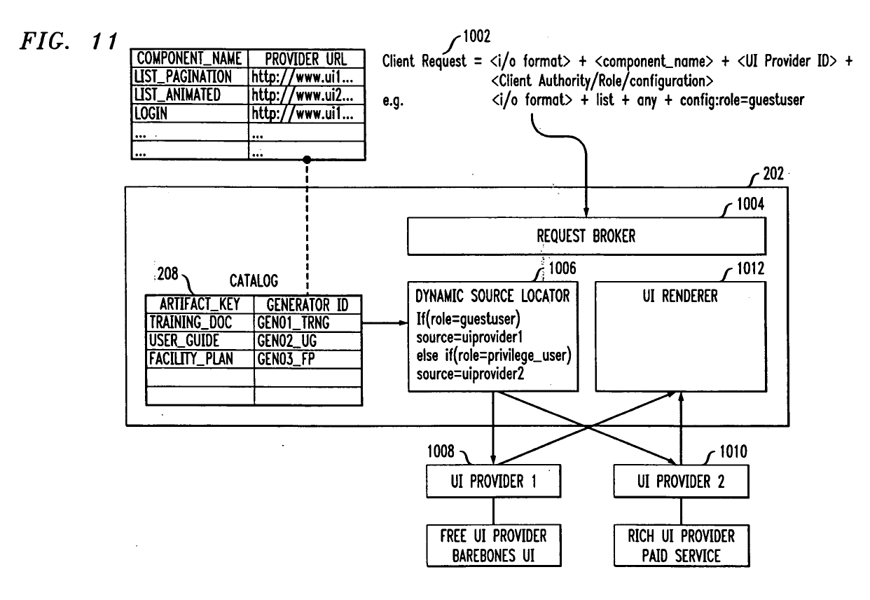

In yet another aspect, with reference to FIG. 12, a single page 1202 can be composed with widgets 1204, 1206, 1208 coming from multiple UI providers 206, though the data is coming from the same content provider service 204. The client request essentially contains multiple components in the request, each of which can be served by a different UI provider; that is, the entire page need not be served by a single provider.

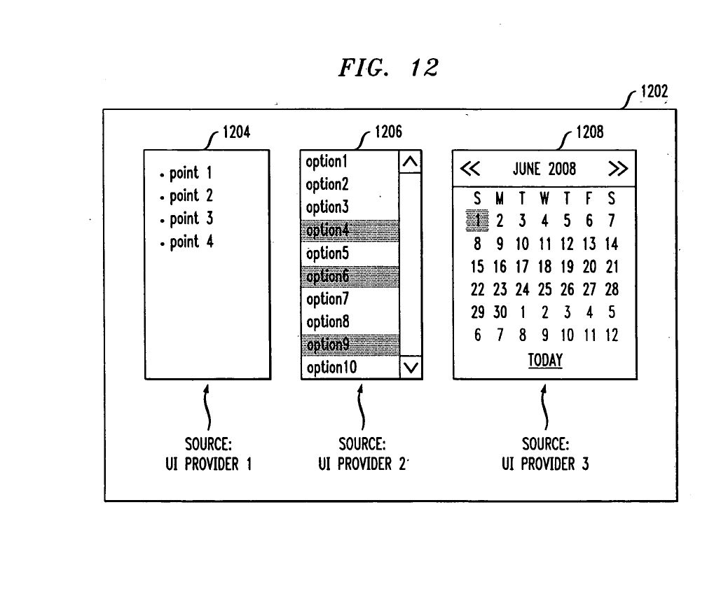

In view of the preceding, it will be appreciated that, in general terms, an exemplary method 1400 (as shown in FIG. 13), according to an aspect of the invention, after beginning at block 1402, includes the step 1404 of determining, with a user interface service composer 202, based on a user interface request from a user interface consumer 210, one of a plurality of user interface service providers 206 to be invoked. Optional steps 1406 and 1408 are discussed below.

Step 1410 includes consulting, by the user interface service composer, a particular entry in a user interface data catalog 208 having a plurality of entries for the plurality of user interface service providers 206. The particular entry corresponds to that given one of the plurality of user interface service providers 206 that is to be invoked. Step 1412 includes routing, from the user interface service composer 202 to the given one of the plurality of user interface service providers 206 that is to be invoked, a request message for rendering a user interface requested in the user interface request received from the user interface consumer. The request message includes at least configuration parameters and interaction-related data, and is formatted in accordance with the particular entry in the user interface data catalog 208.

Step 1414 includes the user interface service composer 202 receiving the requested user interface from the from the given one of the plurality of user interface service providers 206. Step 1416 includes forwarding, by the user interface service composer 202 to the user interface consumer 210, the requested user interface.

Optional step 1406 includes determining, with the user interface service composer 202, based on the user interface request from the user interface consumer 210, one of a plurality of content service providers 204 to be invoked. Optional step 1408 includes fetching, by the user interface service composer 202, from the one of the plurality of content service providers 206 to be invoked, the content to be rendered. In this example, in the routing step 1412, the request message further includes the content to be rendered, and the user interface includes the content to be rendered.

In some cases, an input is obtained from the user interface consumer, by the user interface service composer; for example, as an invocation of an interaction point on the user interface. As per decision block 1418 (YES branch), when this occurs, user interface service composer 202 routes the input to user interface service provider 206, essentially repeating step 1412 (and as needed, any intervening steps 1404-1410). User interface service provider 206 decomposes the input from the user interface consumer, to obtain decomposed data, and forwards same to user interface service composer 202, in an analog of step 1414. Composer 202 processes the data to obtain a new user interface and forwards same to the user interface consumer 210, in an analog of step 1416. In a non-limiting example, the user interface is a login page and the new user interface is a home page.

In some instances, a UI to be rendered, such as the aforementioned login page, does not require content service access, while another UI to be rendered (for example, the new UI, such as the aforementioned home page) does require content service access. In such a case, (repeated) step 1404 includes determining, with the user interface service composer 202, based on the input from the user interface consumer, one of a plurality of content service providers 204 to be invoked. Composer 202 fetches, from the one of the plurality of content service providers to be invoked, the content to be rendered, as per 1408. In step 1412, a specification of the content to be rendered is also routed; and the home page includes the content to be rendered.

When no further input is received, processing continues at block 1420, per the NO branch of block 1418.

As described with regard to FIGS. 10 and 11, in some cases, step 1406 results in a choice of several user interface service providers that can be invoked, and can further include selecting, by the user interface service composer 202, which of the several ones of the plurality of user interface service providers is most appropriate.

As described with regard to FIG. 12, in some cases, at least steps 1404, 1410, 1412, and 1414 can be repeated for at least a second one of the plurality of user interface service providers to be invoked. In such a case, user interface service composer 202 assembles the user interface with items from multiple user interface service providers (for example, widgets 1204, 1206, 1208), as per the parenthetic language in block 1416.

### Exemplary System and Article of Manufacture Details

A variety of techniques, utilizing dedicated hardware, general purpose processors, firmware, software, or a combination of the foregoing may be employed to implement the present invention or components thereof. One or more embodiments of the invention, or elements thereof, can be implemented in the form of a computer product including a computer usable medium with computer usable program code for performing the method steps indicated. Furthermore, one or more embodiments of the invention, or elements thereof, can be implemented in the form of an apparatus including a memory and at least one processor that is coupled to the memory and operative to perform exemplary method steps.

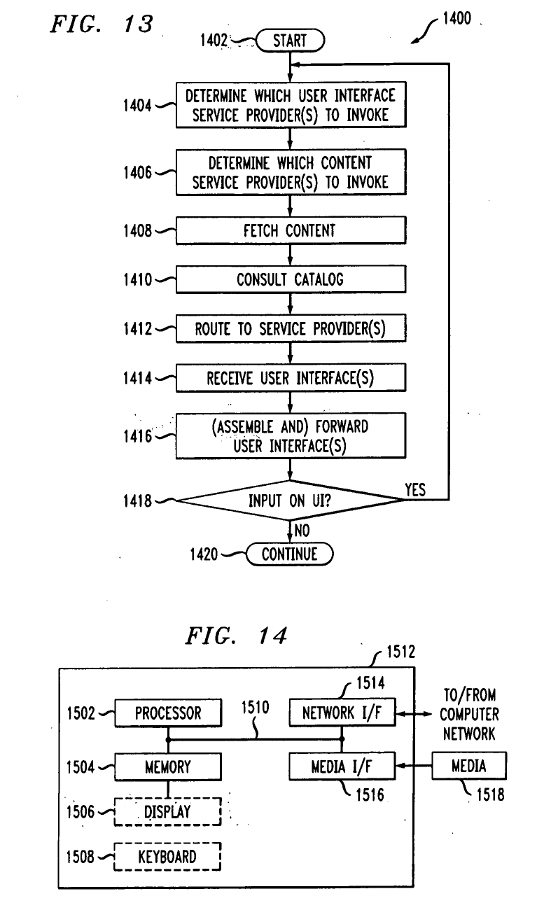

One or more embodiments can make use of software running on a general purpose computer or workstation. With reference to FIG. 14, such an implementation might employ, for example, a processor 1502, a memory 1504, and an input/output interface formed, for example, by a display 1506 and a keyboard 1508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 1502, memory 1504, and input/output interface such as display 1506 and keyboard 1508 can be interconnected, for example, via bus 1510 as part of a data processing unit 1512. Suitable interconnections, for example via bus 1510, can also be provided to a network interface 1514, such as a network card, which can be provided to interface with a computer network, and to a media interface 1516, such as a diskette or CD-ROM drive, which can be provided to interface with media 1518.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 1518) providing program code for use by or in connection with a computer or any instruction execution system. For the purposes of this description, a computer usable or computer readable medium can be any apparatus for use by or in connection with the instruction execution system, apparatus, or device. The medium can store program code to execute one or more method steps set forth herein.

The medium can be an electronic, magnetic, optical, electromagnetic, infrared, or semiconductor system (or apparatus or device) or a propagation medium. Examples of a tangible computer-readable storage medium include a semiconductor or solid-state memory (for example memory 1504), magnetic tape, a removable computer diskette (for example media 1518), a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor 1502 coupled directly or indirectly to memory elements 1504 through a system bus 1510. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards 1508, displays 1506, pointing devices, and the like) can be coupled to the system either directly (such as via bus 1510) or through intervening I/O controllers (omitted for clarity).

Network adapters such as network interface 1514 may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the invention have been described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a tangible computer-readable storage medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising the steps of:
determining, with a user interface service composer, based on a user interface request from a user interface consumer, one of a plurality of user interface service providers to be invoked;
consulting, by said user interface service composer, a particular entry in a user interface data catalog having a plurality of entries for said plurality of user interface service providers, said particular entry corresponding to that given one of said plurality of user interface service providers that is to be invoked;
routing, from said user interface service composer to said given one of said plurality of user interface service providers that is to be invoked, a request message for rendering a user interface requested in said user interface request received from said user interface consumer, said request message comprising configuration parameters and interaction-related data, said request message being formatted in accordance with said particular entry in said user interface data catalog;
receiving, by said user interface service composer from said given one of said plurality of user interface service providers that is to be invoked, said user interface requested in said user interface request received from said user interface consumer; and
forwarding, by said user interface service composer to said user interface consumer, said user interface requested in said user interface request received from said user interface consumer.

2. The method of claim 1, further comprising:
determining, with said user interface service composer, based on said user interface request from said user interface consumer, one of a plurality of content service providers to be invoked; and
fetching, by said user interface service composer, from said one of said plurality of content service providers to be invoked, said content to be rendered;
wherein:
in said routing step, said request message further comprises said content to be rendered; and
said user interface comprises said content to be rendered.

3. The method of claim 1, further comprising:
obtaining, by said user interface service composer, an input from said user interface consumer, as an invocation of an interaction point on said user interface;
routing, by said user interface service composer, to said user interface service provider, said input from said user interface consumer;
decomposing, by said user interface service provider, said input from said user interface consumer; to obtain decomposed data;
forwarding, by said user interface service provider, to said user interface service composer, said decomposed data;
processing, by said user interface service composer, said data, to obtain a new user interface; and
forwarding, by said user interface service composer to said user interface consumer, said new user interface.

4. The method of claim 1, wherein said user interface comprises a login page and wherein said new user interface comprises a home page.

5. The method of claim 4, wherein said login page does not require content service access and wherein said home page does require content service access, further comprising:
determining, with said user interface service composer, based on said input from said user interface consumer, one of a plurality of content service providers to be invoked; and
fetching, by said user interface service composer, from said one of said plurality of content service providers to be invoked, said content to be rendered;
wherein:
in said step of routing said input from said user interface consumer, a specification of said content to be rendered is also routed; and
said home page comprises said content to be rendered.

6. The method of claim 1, wherein said determining, with said user interface service composer, based on said user interface request from said user interface consumer, results in a choice of several ones of said plurality of user interface service providers that can be invoked, further comprising selecting, by said user interface service composer, which of said several ones of said plurality of user interface service providers is most appropriate.

7. The method of claim 1, further comprising repeating said determining, consulting, routing, and receiving steps for at least a second one of said plurality of user interface service providers to be invoked, wherein said user interface service composer assembles said user interface with items from said given one of said plurality of user interface service providers and said at least second one of said plurality of user interface service providers to be invoked.

8. The method of claim 7, wherein said items comprise widgets.

9. A computer program product comprising a tangible computer readable storage medium including computer usable program code, said computer program product including:
computer usable program code for determining, with a user interface service composer, based on a user interface request from a user interface consumer, one of a plurality of user interface service providers to be invoked;
computer usable program code for consulting, by said user interface service composer, a particular entry in a user interface data catalog having a plurality of entries for said plurality of user interface service providers, said particular entry corresponding to that given one of said plurality of user interface service providers that is to be invoked;
computer usable program code for routing, from said user interface service composer to said given one of said plurality of user interface service providers that is to be invoked, a request message for rendering a user interface requested in said user interface request received from said user interface consumer, said request message comprising configuration parameters and interaction-related data, said request message being formatted in accordance with said particular entry in said user interface data catalog;
computer usable program code for receiving, by said user interface service composer from said given one of said plurality of user interface service providers that is to be invoked, said user interface requested in said user interface request received from said user interface consumer; and
computer usable program code for forwarding, by said user interface service composer to said user interface consumer, said user interface requested in said user interface request received from said user interface consumer.

10. The computer program product of claim 9, further comprising:
computer usable program code for determining, with said user interface service composer, based on said user interface request from said user interface consumer, one of a plurality of content service providers to be invoked; and
computer usable program code for fetching, by said user interface service composer, from said one of said plurality of content service providers to be invoked, said content to be rendered;
wherein:
in said computer usable program code for routing, said request message further comprises said content to be rendered; and
said user interface comprises said content to be rendered.

11. The computer program product of claim 9, further comprising:
computer usable program code for obtaining, by said user interface service composer, an input from said user interface consumer, as an invocation of an interaction point on said user interface;
computer usable program code for routing, by said user interface service composer, to said user interface service provider, said input from said user interface consumer;
computer usable program code for decomposing, by said user interface service provider, said input from said user interface consumer; to obtain decomposed data;
computer usable program code for forwarding, by said user interface service provider, to said user interface service composer, said decomposed data;
computer usable program code for processing, by said user interface service composer, said data, to obtain a new user interface; and
computer usable program code for forwarding, by said user interface service composer to said user interface consumer, said new user interface.

12. The computer program product of claim 9, wherein said user interface comprises a login page and wherein said new user interface comprises a home page.

13. The computer program product of claim 12, wherein said login page does not require content service access and wherein said home page does require content service access, further comprising:
computer usable program code for determining, with said user interface service composer, based on said input from said user interface consumer, one of a plurality of content service providers to be invoked; and
computer usable program code for fetching, by said user interface service composer, from said one of said plurality of content service providers to be invoked, said content to be rendered;
wherein:
said computer usable program code for routing said input from said user interface consumer comprises computer usable program code for routing a specification of said content to be rendered; and
said home page comprises said content to be rendered.

14. The computer program product of claim 9, wherein said computer usable program code for determining, with said user interface service composer, based on said user interface request from said user interface consumer, results in a choice of several ones of said plurality of user interface service providers that can be invoked, further comprising computer usable program code for selecting, by said user interface service composer, which of said several ones of said plurality of user interface service providers is most appropriate.

15. The computer program product of claim 9, further comprising computer usable program code for repeating said determining, consulting, routing, and receiving for at least a second one of said plurality of user interface service providers to be invoked, wherein said user interface service composer assembles said user interface with items from said given one of said plurality of user interface service providers and said at least second one of said plurality of user interface service providers to be invoked.

16. The computer program product of claim 15, wherein said items comprise widgets.

17. A system comprising:
a memory; and
at least one processor, coupled to said memory, and operative to:
determine, with a user interface service composer, based on a user interface request from a user interface consumer, one of a plurality of user interface service providers to be invoked;
consult, by said user interface service composer, a particular entry in a user interface data catalog having a plurality of entries for said plurality of user interface service providers, said particular entry corresponding to that given one of said plurality of user interface service providers that is to be invoked;
route, from said user interface service composer to said given one of said plurality of user interface service providers that is to be invoked, a request message for rendering a user interface requested in said user interface request received from said user interface consumer, said request message comprising configuration parameters and interaction-related data, said request message being formatted in accordance with said particular entry in said user interface data catalog;
receive, by said user interface service composer from said given one of said plurality of user interface service providers that is to be invoked, said user interface requested in said user interface request received from said user interface consumer; and
forward, by said user interface service composer to said user interface consumer, said user interface requested in said user interface request received from said user interface consumer.

18. The system of claim 17, wherein said processor is further operative to:
determine, with said user interface service composer, based on said user interface request from said user interface consumer, one of a plurality of content service providers to be invoked; and
fetch, by said user interface service composer, from said one of said plurality of content service providers to be invoked, said content to be rendered;
wherein:
in said routing, said request message further comprises said content to be rendered; and
said user interface comprises said content to be rendered.

19. The system of claim 17, wherein said processor is further operative to:
obtain, by said user interface service composer, an input from said user interface consumer, as an invocation of an interaction point on said user interface;
route, by said user interface service composer, to said user interface service provider, said input from said user interface consumer;
decompose, by said user interface service provider, said input from said user interface consumer; to obtain decomposed data;
forward, by said user interface service provider, to said user interface service composer, said decomposed data;
process, by said user interface service composer, said data, to obtain a new user interface; and
forward, by said user interface service composer to said user interface consumer, said new user interface.

20. The system of claim 17, wherein said user interface comprises a login page and wherein said new user interface comprises a home page.
